(19) United States
(12) Patent Application Publication
(10) Pub. No.: US 2024/0073369 A1
(43) Pub. Date: Feb. 29, 2024

(54) PERSONAL MEETING NOTES ASSISTANT AND METHODS OF ITS USE

(71) Applicant: Seeya Technologies, LLC, Greenwood, SC (US)

(72) Inventors: Christopher M. Ayer, Greenwood, SC (US); Joshua R. Gray, Irmo, SC (US)

(21) Appl. No.: 18/456,103

(22) Filed: Aug. 25, 2023

Related U.S. Application Data
(60) Provisional application No. 63/401,259, filed on Aug. 26, 2022.

(51) Int. Cl. H04N 7/15; H04N 7/14

(52) U.S. Cl. CPC H04N 7/155; H04N 7/142; H04N 7/147

(57) ABSTRACT

A recording device and methods of operation are provided. The recording device includes a panoramic camera system, a plurality of microphones, an antenna, and a processor communicatively coupled to the panoramic camera system and the plurality of microphones. The processors configured to perform one or more operations including recording simultaneous video from the panoramic camera system. The operations further include recording audio from the plurality of microphones with instantaneous transcription and translation of recorded audio. The operations further include automatically upload video, audio, and transcription to a cloud based medium.

### PRIORITY INFORMATION

The present application claims priority to U.S. Patent Application Ser. No. 63/401,259 filed on Aug. 26, 2022, which is incorporated by reference herein for all purposes.

### FIELD

The present disclosure relates to systems and methods for the recording and storing of information created during meetings and encounters.

### BACKGROUND

Personal meetings inherently involve multiple parties and intricate, spontaneous discussions where clarity of the interactions, ideas espoused, and both verbal and non-verbal communication is key to understanding, documenting, and acting on the meeting discussions. It is estimated that as much as 70% of interpersonal communication occurs through nonverbal mechanisms including facial expression, body posturing, and hand gesticulation. Accurate recording of such meetings is not only desired, but critical to success of the individuals and organizations represented. This need ranges from capturing exchanges such as project brainstorming and planning, to interpersonal and professional meetings on subjects of potential conflict, to personal communication with friends and family that may be desired for archival.

When these interactions are later recalled or recounted with conflicting narratives, the results can be disastrous for one or more parties in the conversation—even in cases where no malice is intended between the parties involved. Conflicting recollections, perceptions, and interpretations of both verbal and nonverbal communication can lead to long-lasting and legally significant misperceptions that could be avoided if the communication was accurately captured for later review. Additionally, in meetings involving conflict where a participant decides they do not want the content of their spoken or nonverbal interactions to be available for posthumous analysis and accountability, there is always a potential with current technology to simply take the recording device or storage media and destroy it.

For creative types in artistic or technical areas, many times the act of creation involves an artistic and individual technique which is not realized by the creator, or easily articulated. Efforts after the act of creation or configuration often fall short, because the originator or creator is not self-aware enough to realize acts they have internally or intuitively conducted—but which are critical to successful recreation and documentation of their work product.

There are currently several technological approaches which seek to address certain aspects of this list of deficiencies, but none that can solve them all. Normal audio recording devices such as tape recorders are unable to capture the bulk of communication which is delivered, processed, and interpreted nonverbally. Most visual recording devices like camcorders and other portable video cameras currently available on the market are typically intended for focused video recording, with or without sound data capture. Camera devices featuring 360° or panoramic recording capabilities do not have the ability to accurately track the meeting participants in real time or include the data storage, backup capabilities and transcription required for this purpose.

Similarly, cell phones and tablet computers are typically equipped with both front and back cameras, as well as microphones and speakers which can be used in limited near-range capture and broadcast. These devices currently do not have the capability to capture full 360° visual and audio range and are essentially prevented from doing so based on their primary intended function and consequent form factors of design. These devices are typically used for the primary purpose of telecommunications and minor computer-aided tasks such as email, text, word processing, internet browsing and increasingly audio-video media consumption. The necessary support for these functions requires that the device have hardware and software features which cause unnecessary bloat and system requirements not needed for the current device. Additionally, laptops and desktop computers have all of the same shortcomings as cellphones, but with larger challenges around deviation from their primary design purposes, consequent form factors, and hardware limitations implied by these features.

Recording devices such as home security cameras and police and military style backup cameras typically do not have the technical specifications suitable for the currently envisioned purpose, nor do they typically have the on-board computation support to simultaneously transcribe and translate the meeting contents both locally and remotely on server. Furthermore, these devices are notorious for losing data or being destroyed in field, whether accidentally or intentionally.

Finally, meeting telecommunications systems, although made specifically for the recording of meetings have their own significant limitations. These systems are currently available to serve as highly functional camera and speaker systems. They are currently only available when plugged into hardline power, and do not have independent computational support to enable onboard data manipulation independent of a controlling cellphone, laptop, or computer. They also do not have the ability to store the captured audio-visual data locally or remotely or to analyze the data for the purposes of transcription or translation. These systems are typically built with a focus to support two-way communication, and therefore have relatively large form factors due to the need for speakers to broadcast remote participants sound into the room where the meeting is being hosted.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 depicts an exemplary model in accordance with some embodiments of the present disclosure;

FIG. 2 is a flowchart illustrating a method for recording and transmitting meeting data;

FIG. 3 is an overhead view of an in-person meeting;

FIG. 4 depicts the output display of individuals in a meeting;

FIG. 5 depicts a diagram of an exemplary controller for use in conjunction with the exemplary model of FIG. 1; and

FIG. 6 is a flow diagram of an exemplary method of operating a recording device, such as shown in FIG. 1.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the terms “first,” “second,” and “third” may be used interchangeably to distinguish one component from another and are not intended to signify location or importance of the individual components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Aspects and advantages of the technology will be set forth in part in the following description, or may be obvious from the description, or may be learned through the practice of the technology.

Electronic device manufacturers have discovered the limitations of using electronic means to record human interactions. Most methods of recording events include an element of subjectivity that allows for disagreement or confusion when revisiting the record. Likewise, a large portion of communication is non-verbal and is difficult to record if not seen or understood at the time of recording.

In one aspect, the present subject matter is directed to a system for the full capture of verbal and nonverbal communication in a meeting environment, using an independent, dedicated, specialized meeting notes recording device that simultaneously stores the data locally and remotely as well as draft transcription and translation capabilities. Thus, the data may be protected from destruction of the recording device (either intentionally or unintentionally). The system may include a 360 degree panoramic camera system with split screen focused technology. The system may also be capable of storing the audio-visual data stream locally and remotely on an encrypted web server. The system may include multiple data networking solutions to allow for instantaneous saving of data to a server to avoid local data corruption or destruction. The system may include a rechargeable battery to enable remote operation.

In one aspect, the present subject matter is directed to a device for recording all interactions or communications, verbal and non-verbal, during a business meeting or any other rendezvous where matters discussed are desired to be recorded. The system may include a panoramic camera system, configured to record every participant in a meeting from a central point. This panoramic view will allow for the system to capture all non-verbal communications regardless of who is speaking at any given moment. Furthermore, the system may include a plurality of microphones that will record all conversations and any other auditory communications that may occur during the proceedings. Additionally, the system may include a controller communicatively coupled to the plurality of microphones and the panoramic camera system, with the controller including a processor and associated memory. The memory may store instructions, that when implemented by the processor, allow for immediate transcription and translation of recordings collected by the plurality of microphones. Moreover, the system may include an antenna communicatively coupled with the controller, that when implemented by the processor allows for all recordings, notes, videos, and transcriptions to be uploaded wirelessly to an external storage location (e.g., via wi-fi or cellular communication).

In particular, the recording device may be a stand alone component that operates without connection to a computer or other computing system (e.g., smart phone) such that the recording device operates independently. That is, the recording device may include a controller having a processor with executable instructions therein to operate the recording device without an external computer or computing system, such as described in greater detail below. Thus, the recording device may be deployed simply without having to establish a connection to a computer or other computing system.

In another aspect, the present subject matter is directed to a method for recording and storing all communications, verbal or non-verbal, from all meeting participants that occur during a meeting or interaction. The method may include recording, with one or more recording devices, all visual actions and all oral or auditory occurrences that occur during the given session. Additionally, the method may include a means for instantaneous transfer of all recorded data to an external storage location.

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

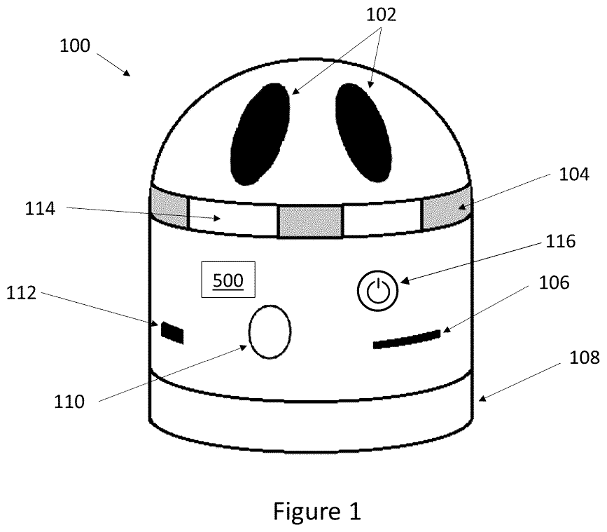

Referring now to the drawings, wherein identical numerals indicate the same elements throughout the figures, FIG. 1 provides a front view of an exemplary recording device 100 as may incorporate various embodiments of the present invention.

As particularly shown by FIG. 1, the recording device 100 includes a panoramic camera system 102 that is configured to capture panoramic views of the entire area around the recording device 100. The exemplary panoramic camera system 102 may be a plurality of cameras affixed to the top of the recording device 100. Alternatively, the exemplary panoramic camera system 102 may be a single camera with a 360-degree panoramic lens. In either embodiment, a full 360-degree view of the entire area is achieved via the panoramic camera system 102.

Optionally, the recording device 100 includes a plurality of microphones 104. The microphones 104 surround the model to allow for best performance when recording from any direction relative to the recording device 100. The plurality of microphones 104 alternate around the recording device 100 with a plurality of speakers 114. The speakers 114 similarly surround the recording device 100 to allow for best performance when playing recorded audio. The plurality of speakers 114 allow for playback of recorded audio from the plurality of microphones 104 to serve as a test to ensure proper functionality.

In one embodiment, the recording device 100 also includes a SIM (Subscriber Identity Module) card slot 106. If present, a SIM card inserted into the SIM card slot 106 allows for data transfer via network communication to a data network (e.g., cellular network) such that the recorded audio and video is transferred to a network storage location external to the recording device 100 (e.g., a cloud-based storage location on a remote computing device).

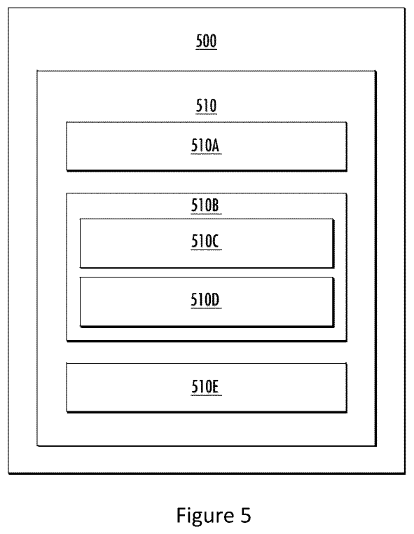

The lower portion of the recording device 100 comprises a battery 108. The battery 108 may be removable to allow for multiple batteries in the event the currently installed battery 108 is depleted. Likewise, the battery 108 may be recharged from a power source by plugging in a cable to the port 112. The port 112 also serves as a medium for connecting the recording device 100 to an external device (such as the controller 500 of FIG. 5) to allow for data transfer. The recording device 100 also includes an antenna 110 to allow for wireless operation. The antenna 110 may include both wireless capabilities as well as Bluetooth.

In many embodiments, as shown in FIG. 1, the recording device 100 may further include a power button or switch 116. The power button 116 may be a physical or digital switch that controls the flow of electricity to the various sub-components of the recording device. When a physical button, pressing the power button or switch 116 may initiate recording of audio and video with the recording device (e.g., by providing power to the panoramic camera system, the microphones, and the internal computing components of the recording device 100). Conversely, recording may be initiated via a digital signal sent to the recording device 100 to initiate the digital switch (e.g., an executable instruction communicated to the recording device 100 via a wireless signal sent from a computer or computing device, such as a smartphone). Additionally or alternatively, the recording device 100 may include a recording button that is separate from the power button, such that the device may be first powered on with the power button and recording video/audio may be subsequently initiated by pressing the recording button.

In one particular embodiment, recording of audio and video may be initiated by a sensing signal from at least one component of the recording device 100 (e.g., the panoramic camera system 200, the plurality of microphones 206, a motion sensor, or another sensing device) upon detection of an initiating signal. For example, when the panoramic camera system 200 detects movement (either a single moving signal or more than one moving signal indicating at least two people in a room), then the recording device 100 may initiate the recording of audio and video. Alternatively, when the plurality of microphones 206 detects voices, then the recording device 100 may initiate the recording of audio and video. In one particular embodiment, the recording device 100 may initiate the recording of audio and video upon detection of predetermined key words or phrases (e.g., aggressive language, inappropriate language, etc.). Such initiation may be performed from the controller 500, with executable instructions stored within a processor therein as discussed with respect to FIG. 5.

The recording device 100 may be a relatively small device configured to be portable and easily deployed (e.g., onto a desk). For example, the largest dimension of the recording device 100 may be 5 inches or less (e.g., in particular embodiments may be 1 inch to 4 inches).

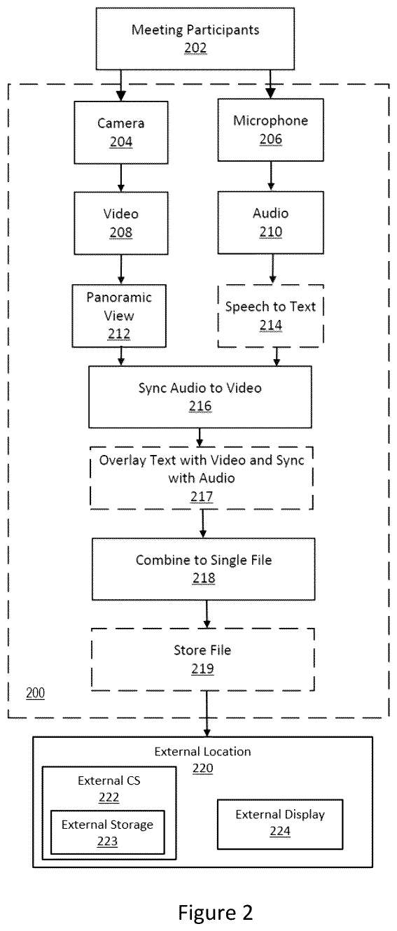

FIG. 2 shows an exemplary meeting recording system 200. The meeting recording system 200 may include a plurality of cameras 204 and a plurality of microphones 206. The recording device 100 may also include an onboard controller 500 operably connected to the panoramic camera system 200, the microphone(s) 206, the power button, the antenna, and other components of the recording device 100.

Upon activation (either passive activation or active activation), the panoramic camera system 204 and the plurality of microphones 206 will capture the video 208 and audio 210 from all of the meeting participants 202. The exemplary meeting recording system 200 may simultaneously process the video 208 and the audio 210. The onboard controller 500 may alter the raw video 208 to create a panoramic view 212, making it simpler to view when an individual desires to watch. Additionally or alternatively, the onboard controller 500 may alter the raw video 208 to create and store focused videos of each participant detected in the panoramic view 212. Likewise, the onboard controller 500 may translate the raw audio 210 into text 214 to allow for a written transcript. The onboard controller 500 may then combine the audio 210 and the video 208 to ensure the two inputs are synced together 216. Subsequently, or simultaneously, the onboard controller 500 may overlay the transcribed text with the video and sync with the audio 217. Afterwards, the onboard controller 500 may combine all of the data into a single file 218. The meeting recording system 200 may then store the file 219 locally and/or transmit the data package to an external location 220, such as an external computing system (CS) 222 (which may include an external storage 223) and/or an external display 224. The external storage may be a cloud based medium, external server, or other external storage.

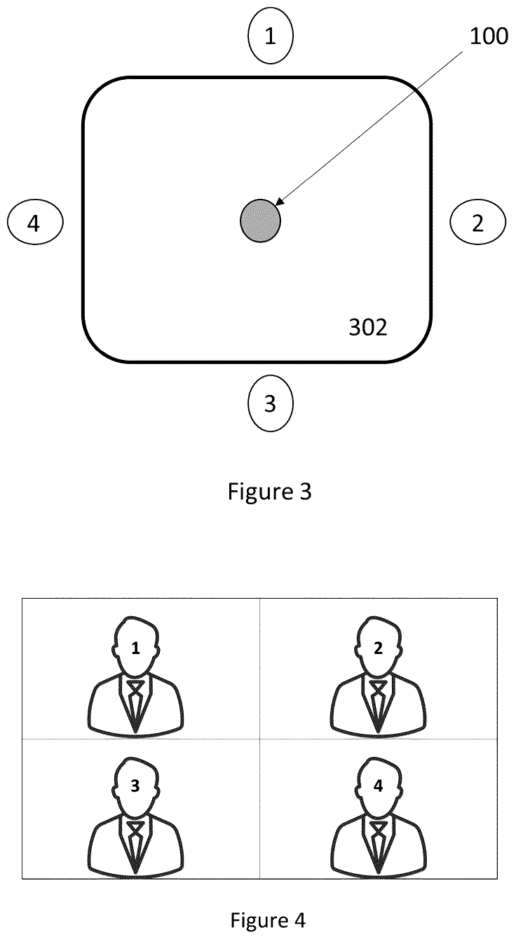

FIG. 3 depicts an overhead view of a meeting with four participants. The system 100 is positioned between the participants on a table or stand 302. The participants are circled around the system 100. The exemplary system 100 may record all four participants simultaneous using a plurality of cameras 102. The recorded output is displayed in FIG. 4. While the participants are surrounding the recording device 100 the processor can display the video in a more suitable format for viewing.

As noted above, the recording device 100 may be in communication with a controller 500, such as shown in FIG. 5. The controller 500 is configured to receive the data from the meeting recording system 200. In one or more exemplary embodiments, the controller 500 may be a stand-alone controller 500, or alternatively, may be integrated into the recording device 100.

Referring particularly to the operation of the controller 500, in at least certain embodiments, the controller 500 can include one or more computing device(s) 510. The computing device(s) 510 can include one or more processor(s) 510A and one or more memory device(s) 510B. The one or more processor(s) 510A can include any suitable processing device, such as a microprocessor, microcontroller, integrated circuit, logic device, and/or other suitable processing device. The one or more memory device(s) 510B can include one or more computer-readable media, including, but not limited to, non-transitory computer-readable media, RAM, ROM, hard drives, flash drives, and/or other memory devices.

The one or more memory device(s) 510B can store information accessible by the one or more processor(s) 510A, including computer-readable instructions 510C that can be executed by the one or more processor(s) 510A. The instructions 510C can be any set of instructions that when executed by the one or more processor(s) 510A, cause the one or more processor(s) 510A to perform operations. In some embodiments, the instructions 510C can be executed by the one or more processor(s) 510A to cause the one or more processor(s) 510A to perform operations, such as any of the operations and functions for which the controller 200 and/or the computing device(s) 510 are configured, the operations for translation of the raw audio and/or video from the data meeting recording system 200, as described herein, and/or any other operations or functions of the one or more computing device(s) 510. The instructions 510C can be software written in any suitable programming language or can be implemented in hardware. Additionally, and/or alternatively, the instructions 510C can be executed in logically and/or virtually separate threads on the one or more processor(s) 510A. The one or more memory device(s) 510B can further store data 510D that can be accessed by the one or more processor(s) 510A.

The computing device(s) 510 can also include a network interface 510E used to communicate, for example, with the other components of the recording device 100, the data meeting recording system 200, etc. The network interface 510E can include any suitable components for interfacing with one or more network(s), including for example, transmitters, receivers, ports, controllers, antennas, and/or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single recording device 100 or multiple recording devices 100 working in combination. Databases, memory, instructions, and applications can be implemented on a recording device 100 or distributed across recording devices 100. Distributed recording devices 100 can operate sequentially or in parallel.

As in the multitude of systems referenced above, more than one meeting recording system 200 could be further networked to cover a larger meeting or discussion space, with the multiple camera visual data streams and audio streams capable of being integrated into a single reviewable record of the discussion or event. For example, multiple recording devices 100 may be networked together to recreate the participants within the space. For instance, the multiple recording devices 100 may use an echo location technology (via the microphones and speakers of the respective multiple recording devices 100) programed within the controller 500 to determine their relative spacing within the room (e.g., mapping of the room via echo location). Further, the multiple recording devices 100 may utilized such echo location technology to recreate the location of participants in the meeting space (e.g., mapping of the room via echo location).

In other instance of the described system, the form factor may be chosen so that the meeting recording system 200 becomes a wearable device which is capable of the same technical data collection as described above.

It is also anticipated that the software used to control the meeting recording system 200 can be independently developed into a stand-alone app for mobile or other computing devices. This software or app is also intended to be covered under the declarations covered in this application.

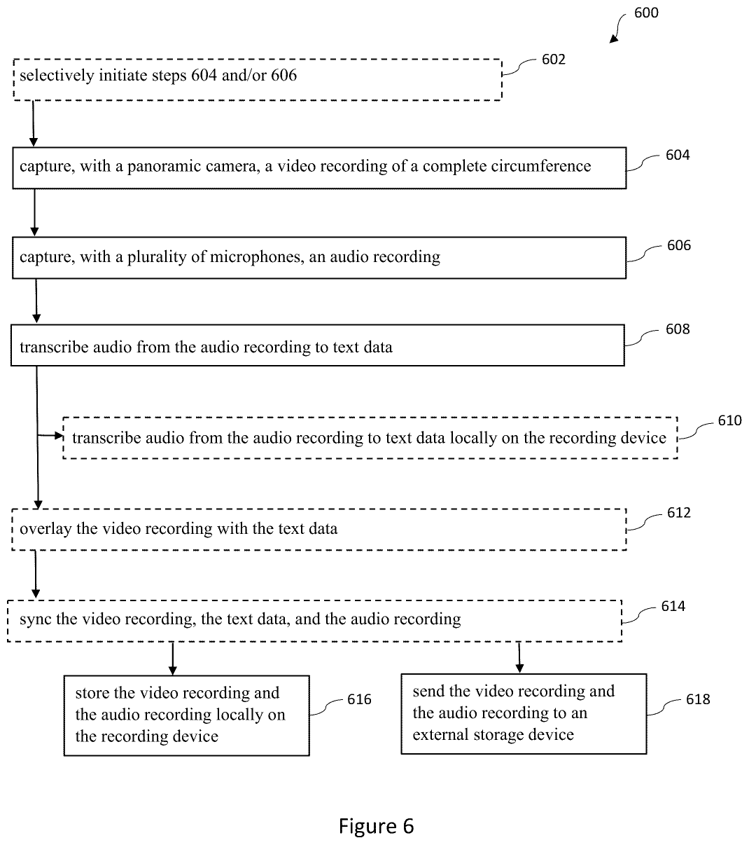

Referring now to FIG. 6, a flow diagram of one embodiment of a method 600 of operating a recording device is illustrated in accordance with embodiments of the present subject matter. In general, the method 600 will be described herein with reference to the recording device 100, the recording system 200, and the controller 500 described above with reference to FIGS. 1 through 5. In addition, although FIG. 6 depicts steps performed in a particular order for purposes of illustration and discussion, the methods discussed herein are not limited to any particular order or arrangement unless otherwise specified in the claims. One skilled in the art, using the disclosures provided herein, will appreciate that various steps of the methods disclosed herein can be omitted, rearranged, combined, and/or adapted in various ways without deviating from the scope of the present disclosure. Dashed boxes indicate optional steps of the method 600.

As shown in FIG. 6, the method 600 may include at (604) capturing, with a panoramic camera, a video recording of a complete circumference. The panoramic camera may utilize multiple lenses or a single wide angle lens to cover the complete circumference (e.g., up to 360°), thereby enabling the recording device to monitor multiple participants in a meeting or other event. The panoramic camera may be operably coupled to a controller, which may stitch together the images from the multiple lenses into a single image or video recording. The method 600 may further include, at (606) capturing, with a plurality of microphones, an audio recording. In exemplary embodiments, capturing the video recording and capturing the audio recording may occur simultaneously. For example, steps 604 and 606 may be selectively initiated (e.g., by a user for active initiation or a controller for passive initiation). That is, the method 600 may include, at (602), simultaneously initiating steps 604 and 606. Step 602 may be done by selectively pressing a power button or switch 116 or recording button positioned on the recording device and electrically connected to the panoramic camera and the plurality of microphones. Alternatively, step 602 may be done by a controller in wireless communication with the recording device 100. In still another embodiment, step 602 may be done in response to one or more sensor signals of a sensor operably connected to the recording device 100. For example, the sensor may be an infrared (IR) camera, an analytical detection that could use standard chemical analysis like spectroscopy or gas detection, etc., which may be configured to send a signal to the controller 500 upon the detection of a predetermined signal within the sensor to begin recording.

In many embodiments, the method 600 may further include at (608) transcribing audio (e.g., audio data) from the audio recording into text data. In exemplary embodiments, transcribing audio from the audio recording to text data may be performed locally on the recording device by one or more processors physically affixed thereto (e.g., by one or more processors of the controller 500). That is, in exemplary embodiments, transcribing at (608) may further include transcribing the audio from the audio recording to text data locally on the recording device. In this way, the audio data does not need to leave the recording device for transcription, which advantageously allows the recording device to operate as a standalone unit.

In many embodiments, the controller connected to (e.g., physically connected to and operably connected to) the recording device can include a speech transcription module, which receives the audio data from the audio recording and outputs a transcription of the audio, such as a word, a phrase, a sentence, a series of sentences, or an entire conversation. To accomplish the transcription, one or more models for transcribing audio data can be used, such as speech recognition models, speech segmentation modules, and the like.

In exemplary embodiments, the method 600 may further include at (612) overlaying the video recording with the text data. This may be performed locally on the recording device by the controller 500 through one or more post processing procedures (such as timestamp alignment procedures and/or text overlay procedures). The method 600 may further include at (614) syncing the video recording, the audio recording, and the text data (e.g., such that the audio, transcription, and video are aligned in the final video file). This may be accomplished by aligning the timecodes of the audio data, the video data, and/or the transcription data. Once aligned, the final file may be stored locally on the recording device (e.g., in a memory device 510B, as discussed below) and/or sent to an external location (such as a display, external computing system, and/or external storage system) via a network communication (e.g., utilizing a removable storage device, such as a USB card inserted into a USB card slot in the recording device 100).

For example, the method 600 may further include at (616) storing the video recording and the audio recording locally on the recording device. For example, the video recording and the audio recording may be stored in the memory devices 510B of the computing system 510. In many embodiments, storing the video and audio recording locally on the recording device may occur in real time (e.g., as the video and audio is being captured by the recording device it is simultaneously being stored in the memory devices attached to the recording device).

Alternatively, or additionally, the method may include at (618) sending the video recording and the audio recording to an external storage device (such as a cloud storage system, external server, external memory device, external computing system, or other device that is not physically affixed to the recording device). In some embodiments, the external storage device is included in an external computing system. In such embodiments, transcribing audio from the audio recording to text data is performed by the external computing system. In many implementations, sending the video recording and the audio recording occurs in real time (e.g., as the video and audio is being captured by the recording device it is simultaneously being sent to an external storage device), which may be done by the a wireless communication device of the controller or the antenna 110. In various implementations, the method 600 may include performing only one of steps 616 or 618. However, in some implementations, the method 600 may include performing both step 616 and step 618. In such implementations, step 616 may occur prior to step 618 (e.g., the video/audio recordings may be stored locally prior to being sent to an external storage device).

In exemplary implementations, the method 600 does not include displaying the recorded audio/video. That is, the audio/video may be selectively captured, stored, and the audio transcribed by the portable recording device without having to be displayed. As such, the method 600 may capture a record of the meeting for future evidence of the event. However, in some implementations, the method 600 may include displaying a panoramic video of the video recording in a side-by-side viewable display.

In some implementations, the method may include supplying power to the recording device by an external source via a cable. In other implementations, the method may include supplying power to the recording device by a removable battery (which may be housed within the recording device or coupled thereto). In some implementations, the method may include transmitting the recorded audio from speakers on the recording device. That is, after the audio is recorded, it may be played back via the onboard speakers of the recording device.

In various implementations, the method 600 may include the audio/video recordings wirelessly by an antenna affixed to the recording device. In other embodiments, the method 600 may include sending the audio/video recordings via a wired connection with a wired communication interface.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

We claim:

1. A method of operating an independent recording device, the method comprising:
capturing, with a panoramic camera system in the recording device, a video recording of a complete circumference;
capturing, with a plurality of microphones in the recording device, an audio recording; and
performing at least one of:
storing the video recording and the audio recording locally on the recording device; or
sending the video recording and the audio recording to an external storage device.

2. The method of claim 1, further comprising:
transcribing audio from the audio recording to text data.

3. The method of claim 2, wherein transcribing audio from the audio recording to text data is performed locally on the recording device by one or more processors physically affixed thereto.

4. The method of claim 3, further comprising:
overlaying the video recording with the text data; and
syncing the video recording, the text data, and the audio recording.

5. The method of claim 2, wherein the external storage device is included in an external computing system, and wherein transcribing audio from the audio recording to text data is performed by the external computing system.

6. The method of claim 1, wherein capturing the video recording and capturing the audio recording occurs simultaneously.

7. The method of claim 1, further comprising:
selectively initiating capturing the video recording and the audio recording.

8. The method of claim 7, wherein selectively initiating capturing the video recording and the audio recording occurs upon receipt of a signal from a sensor within the independent recording device.

9. The method of claim 1, wherein storing the video recording and the audio recording locally on the recording device occurs in real time.

10. The method of claim 1, wherein sending the video recording and the audio recording occurs in real time.

11. The method of claim 1, further comprising:
performing both the storing step and the sending step.

12. The method of claim 11, wherein the sending step occurs after the storing step.

13. The method of claim 11, wherein the sending step comprises transmitting the video recording and the audio recording via a SIM card inserted within a SIM card slot of the recording device.

14. The method of claim 1, displaying a panoramic video in a side-by-side viewable display.

15. The method of claim 1, further comprising:
transmitting the recorded audio from speakers on the recording device.

16. The method of claim 1, wherein sending is performed by an antenna affixed to the recording device.

17. The method of claim 1, wherein sending is performed with a wired communication interface.

18. A recording device comprising:
a panoramic camera system;
a plurality of microphones;
an antenna; and
a processor communicatively coupled to the camera and the plurality of microphones configured for:
recording simultaneous video from the panoramic camera system;
recording audio from the plurality of microphones;
with instantaneous transcription and translation of recorded audio; and
automatically upload video, audio, and transcription to a cloud based medium.

19. The recording device of claim 18, further comprising:
a plurality of speakers and the processor further configured to transmit previously recorded audio from the plurality of speakers.

20. The recording device of claim 18, further comprising:
a programmable memory capable of storing video, audio, and transcription until able to upload to a cloud based medium.
